(19) United States
(12) Patent Application Publication
(10) Pub. No.: US 2012/0121380 A1
(43) Pub. Date: May 17, 2012

(54) KINETIC ENERGY TRANSFORMING MODULE

(76) Inventor: Pe-Pin Tein, Kaohsiung County (TW)

(21) Appl. No.: 12/947,820

(22) Filed: Nov. 16, 2010

(51) Int. Cl. F03D 7/06

(52) U.S. Cl. 415/4.2

(57) ABSTRACT

A kinetic energy transforming module includes a main shaft perpendicularly and rotatably standing on supporting surface and at least one blade structure horizontally mounted on the main shaft for driving the main shaft via wind power. The blade structure includes a horizontal shaft, an upper fan blade and a lower fan blade. The horizontal shaft is fixed on the main shaft. The two fan blades are respectively hinged on the horizontal shaft. Combining these three pieces together becomes a plane, perfect arc or a half circle shape. Find suitable place on the horizontal shaft building some stoppers to control the upper fan blade rotation angle from 5 to 90 degrees, and the lower blade rotation angle from −15 to −90 degrees. Hence, the blade structure is able to keep blades rotating and accelerating to achieve higher wind power efficiency.

### BACKGROUND OF THE INVENTION

1. Field of the Invention

The present invention relates to a transforming module, and more particularly to a kinetic energy transforming module that effectively uses wind power to drive a generator.

2. Description of Related Art

Conventional ways for generating electric power usually use thermal energy, kinetic energy from water or nuclear energy. However, thermal power exhausts great carbon dioxide (CO₂), nuclear energy produces nuclear waste that can not be decomposed and water energy needs to build a dam. Consequently, the conventional ways for generating electric power not only damage environment but also cost lots of money. As a result, windmills are used to drive a generator. However, the blades of the conventional windmills are fixed and uniformed such that the conventional windmills can not effectively use the wind power and the generating rate accordingly becomes low.

The present invention has arisen to mitigate and/or obviate the disadvantages of the conventional windmills that are provided for generating electric power.

### SUMMARY OF THE INVENTION

The main objective of the present invention is to provide an improved kinetic energy transforming module that effectively uses wind power to drive a generator.

To achieve the objective, the kinetic energy transforming module in accordance with the present invention comprises a main shaft perpendicularly and rotatably standing on supporting surface. At least one blade structure is horizontally mounted on the main shaft for driving the main shaft via wind power and keeping the upper and lower fan blades rotating and accelerating to achieve higher wind power efficiency. The blade structure includes multiple shafts horizontally and radially extending from the main shaft. Each shaft has a curve upper groove and a curve lower groove respectively and transversely defined in an outer periphery thereof, wherein the upper groove has two opposite sides respectively formed with a lower stopper and an upper stopper. A first includes angle is formed between the lower stopper and the horizontal plane being greater than 0 degree, and a second included angle is formed between the upper stopper and the horizontal plane being smaller than 90 degrees. The lower groove has a lower side formed with a stopper that is vertical relative to the horizontal plane. An upper fan blade and a lower fan blade respectively have a hinged side pivotally sleeved on the shaft such that the upper fan blade and the lower fan blade can be freely rotated relative to the shaft within the upper groove and the lower groove.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a kinetic energy transforming module in accordance with the present invention;

FIG. 2 is a cross-sectional view of a shaft with an upper fan blade and a lower fan blade of the kinetic energy transforming module in accordance with the present invention;

FIG. 3 is a perspective view of a second embodiment of the kinetic energy transforming module in accordance with the present invention;

FIG. 4 is a front plan view of the kinetic energy transforming module in FIG. 3;

FIG. 5 is a perspective view of a third embodiment of the kinetic energy transforming module in accordance with the present invention;

FIG. 6 is a first operational view of the generating device of the kinetic energy transforming module in FIG. 5;

FIG. 7 is a second operational view of the generating device of the kinetic energy transforming module in FIG. 5;

FIG. 8 is a perspective view of a fourth embodiment of the kinetic energy transforming module in accordance with the present invention;

FIG. 9 is a perspective view of a fifth embodiment of the kinetic energy transforming module in accordance with the present invention;

FIG. 10 is a cross-sectional view of a cam of the kinetic energy transforming module in FIG. 9;

FIG. 11 is a partially cross-sectional view of the kinetic energy transforming module in FIG. 9;

FIG. 12 is an operational view of the kinetic energy transforming module in FIG. 9;

FIG. 13 is a perspective view of a sixth embodiment of the kinetic energy transforming module in accordance with the present invention;

FIG. 14 is a partial front plan view of the kinetic energy transforming module in FIG. 13 when the wind stops;

FIG. 15 is a partial front plan view of the kinetic energy transforming module in FIG. 13 when the blade structure is rotated; and

FIG. 16 is a perspective view of a seventh embodiment of the kinetic energy transforming module in accordance with the present invention.

### DETAILED DESCRIPTION OF THE INVENTION

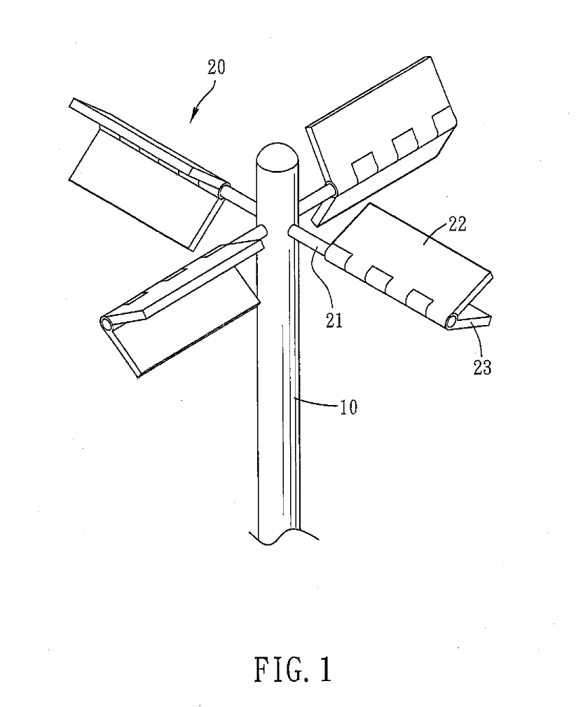

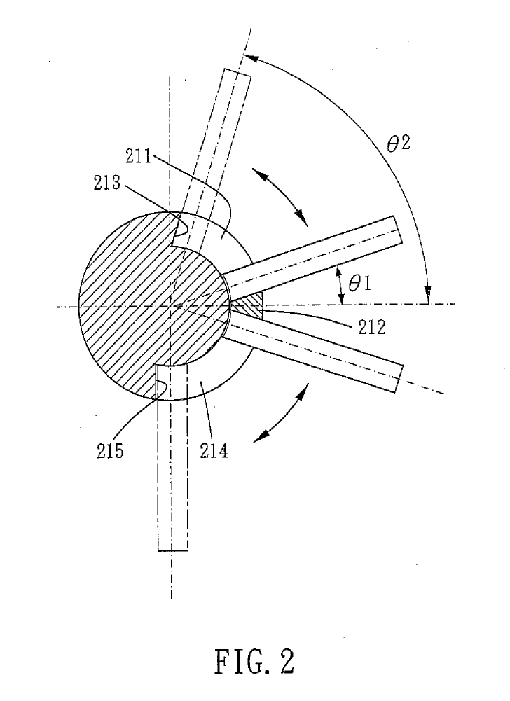

Referring to the drawings and initially to FIGS. 1-2, a kinetic energy transforming module, such as a windmill, in accordance with the present invention comprises main shaft (10) perpendicularly and rotatably standing on a supporting surface (not shown) and connected to a generator (not shown) and at least one blade structure (20) horizontally mounted on the main shaft (10) for driving the main shaft (10) via wind power. The generator is operated when the main shaft (10) is rotated.

The blade structure (20) includes multiple shafts (21) horizontally and radially extending from the main shaft (10), an upper fan blade (22) and a lower fan blade (23) respectively having a hinged side pivotally sleeved on the shaft (21) such that the upper fan blade (22) and the lower fan blade (23) can be freely rotated relative to the shaft (21). In addition, the rotation angle of the upper fan blade (22) is limited within 5 to 90 degrees and the rotation angle of the lower fan blade (23) is limited within −15 to −90 degrees. Hence, the blade structure (20) in accordance with the present invention is able to keep the upper and lower fan blades (22, 23) rotating and accelerating to achieve higher wind power efficiency.

The shaft (21) has a curve upper groove (211) and a curve lower groove (214) respectively and transversely defined in an outer periphery thereof, wherein the upper groove (211) has two opposite sides respectively formed with a lower stopper (212) and an upper stopper (213). A first includes angle (θ1) formed between the lower stopper (212) and the horizontal plane is greater than 0 degree, and a second included angle θ2) formed between the upper stopper (213) and the horizontal plane is smaller than 90 degrees. The lower groove (214) has a lower side formed with a stopper (215) that is vertical relative to the horizontal plane.

The upper fan blade (22) has a lower side movably received in the upper groove (211) and moved along the upper groove (211), and the lower fan blade (23) has an upper side movably received in the lower groove (214) and moved along the lower groove (214).

The upper fan blade (22) has a back side moved to abut against the upper stopper (213) of the upper groove (211) and the lower fan blade (23) has a back side abutting against the stopper (21.5) of the lower groove (214) for driving the main shaft (10) via the shaft (21) when the upper fan blade (22) and the lower fan blade (23) face the wind. The upper fan blade (22) is moved to abut against the lower stopper (212) of the upper groove (211) due to its gravity and the wind power, and the lower fan blade (23) moved toward the upper fan blade (22) due to the wind power for reducing the leeward area and enhancing the use rate of the wind power when the upper fan blade (22) and the lower fan blade (23) are in a condition of leeward.

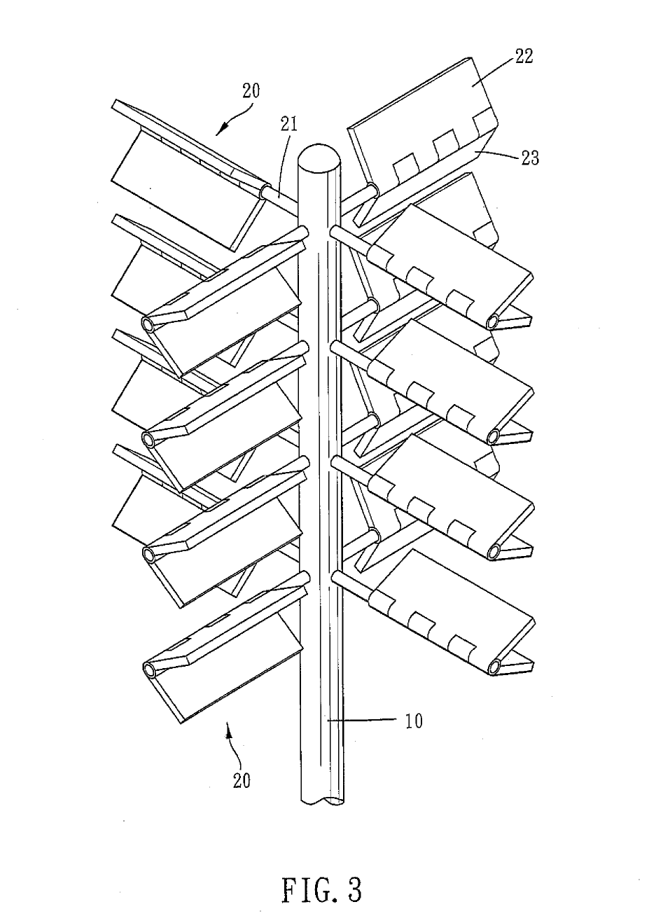

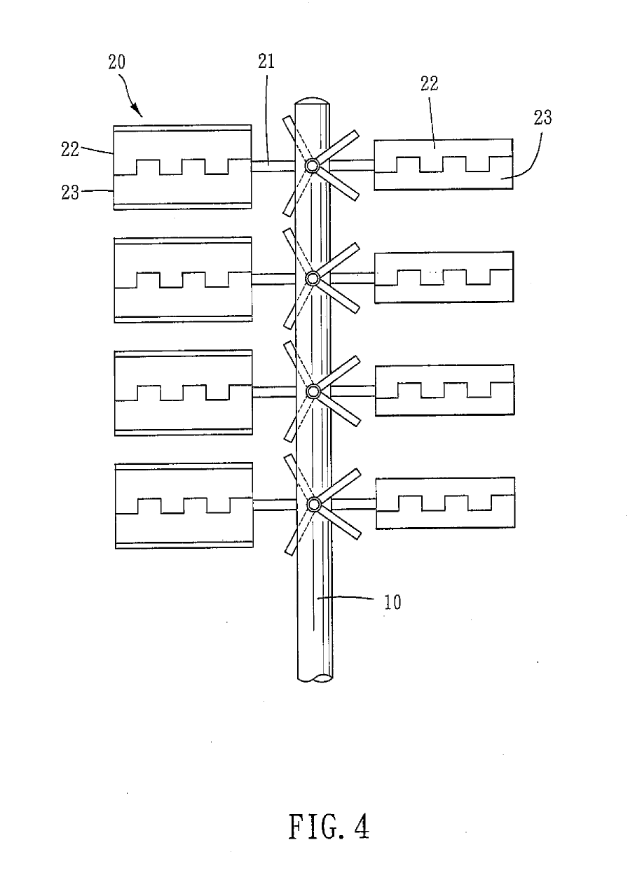

With reference to FIGS. 3 and 4 that show a second embodiment of the kinetic energy transforming module in accordance with the present invention, in the embodiment, multiple blade structures (20) are parallel to one another and sequentially mounted on the main shaft (10) for providing heavy power when the load of the main shaft (10) is great.

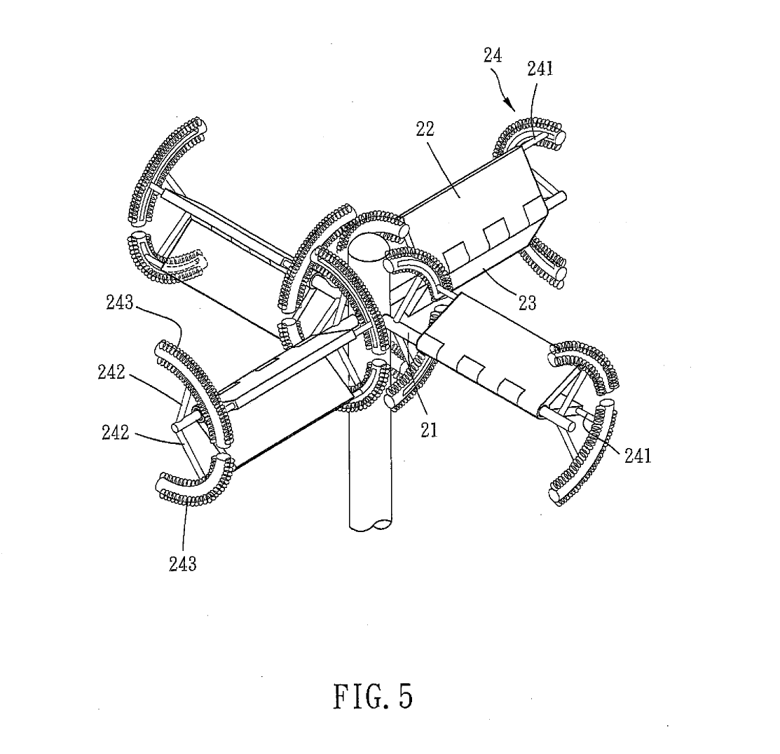

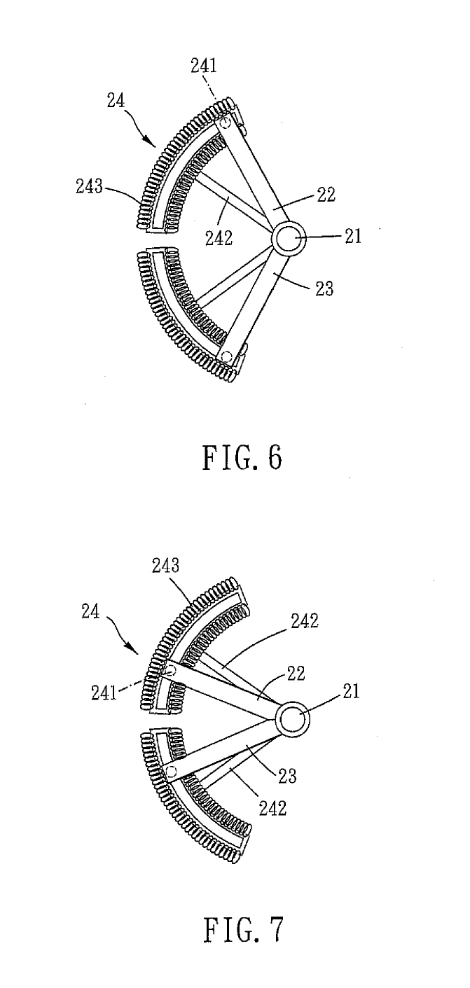

With reference to FIGS. 5 to 7 and the first embodiment, described above, which show a third embodiment of the kinetic energy transforming module in accordance with the present invention, the shaft (21) has two opposite ends each having a generating device (24) mounted thereon. Each generating device (24) has two permanent magnets (241) respectively laterally extending from a corresponding edge of the upper fan blade (22) and the lower fan blade (23). Two connecting rods (242) radially extend from the shaft (21) and a curve induction coil (243) secured on a free end of each of the two connecting rods (242). Each induction coil (243) corresponds to a moving route of a corresponding one of the two permanent magnets (241) such that the generating device (24) generates electric power due to the Faraday Law when the upper fan blade (22) and the lower fan blade (23) are wiggles relative to the shaft (21).

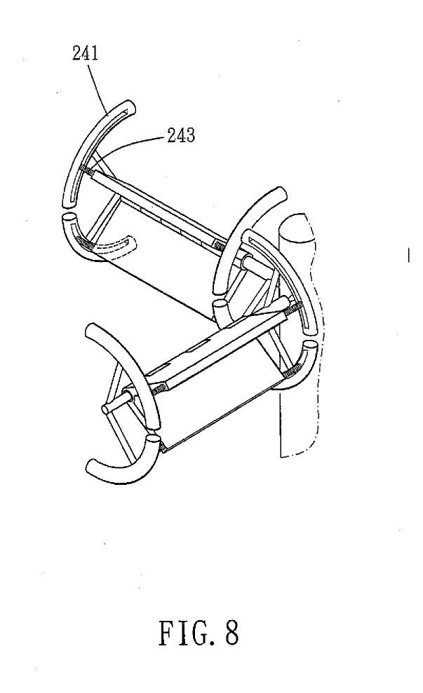

With reference to FIG. 8 that shows a fourth embodiment of the kinetic energy transforming module in accordance with the present invention, in the embodiment, the positions and the shapes of the permanent magnet (241) and the induction coil (243), as described in the third embodiment, are exchanged.

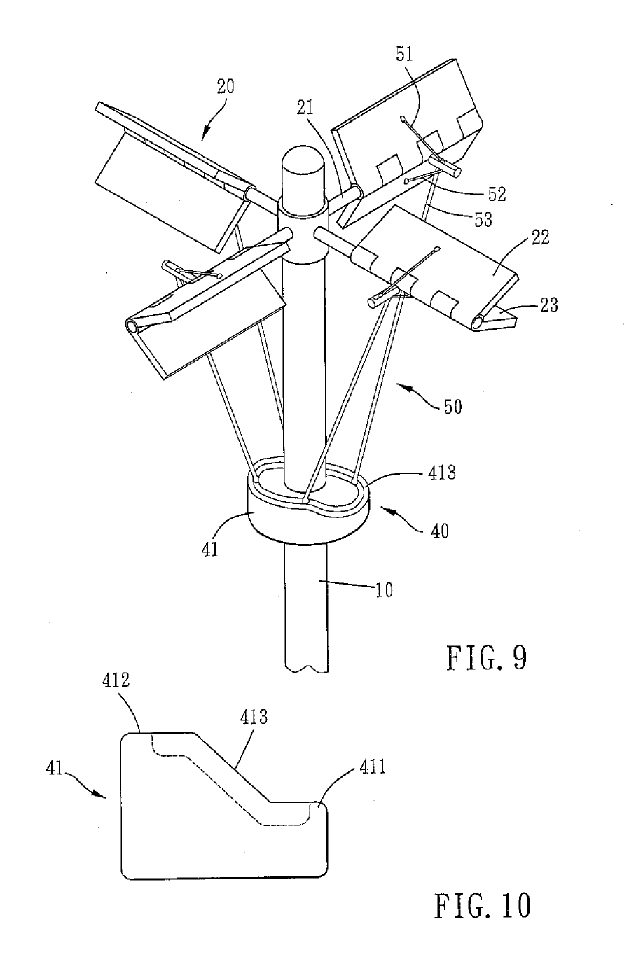

With reference to FIGS. 9 to 11 that show a fifth embodiment of the kinetic energy transforming module in accordance with the present invention, in the embodiment, the blade structure (20) further comprises a driving unit (40) sleeved on the main shaft (10) and a linkage set (50) connecting to the upper fan blade (22) and the lower fan blade (23) for operating the upper fan blade (22) and the lower fan blade (23).

The driving unit (40) includes a cam (41) sleeved on the main shaft (10) and the main shaft (10) is rotatable relative to the can (41). The cam (41) has an upper surface divided into a concave portion (411) and convex portion (412), and an annular groove (413) defined along the concave portion (411) and the convex portion (412). The linkage set (50) includes an upper linkage (51), a lower linkage (52) and a drive linkage (53) pivotally connected to one another. The upper linkage (51) and the lower linkage (52) respectively have a first end pivotally connected to a back of the upper fan blade (22) and a back of the lower fan blade (23), and a second end pivotally connected to each other. The drive linkage (53) has a first end pivotally connected to the second ends of the upper linkage (51) and the lower linkage (52), and a second slidably received in the annular groove (413). A guide rod (54) is horizontally connected to the shaft (21) and has a groove (541) longitudinally defined therein for slidably receiving the first end of the drive linkage (53) and two second ends of the upper linkage (51) and the lower linkage (52).

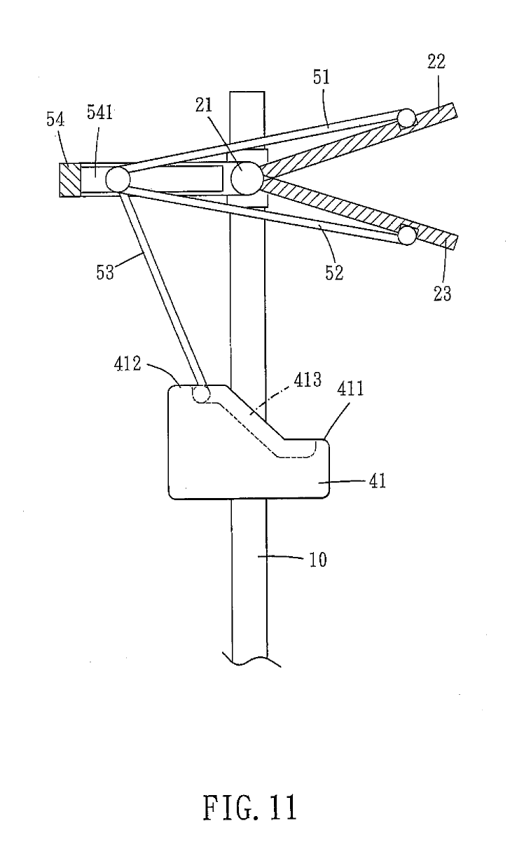

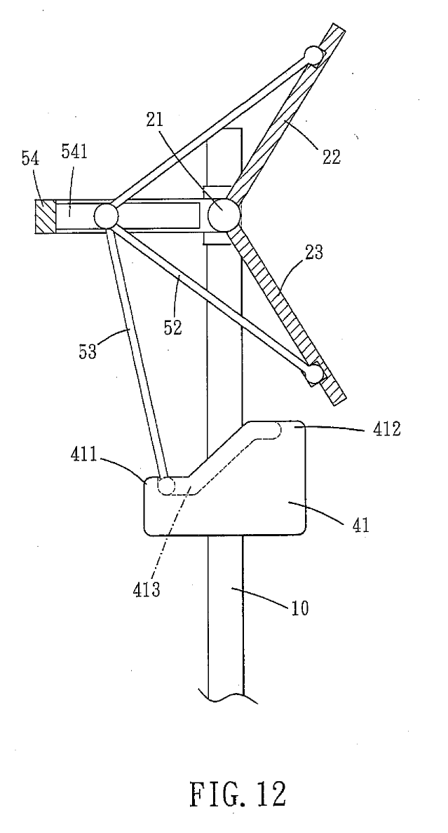

With reference to FIGS. 11 and 12, the second end of the drive linkage (53) is moved along the annular groove (413) relative to the cam (41) when the blade structure (20) is rotated due to the wind power. The second end of the drive linkage (53) is moved in the annular groove (413) within the convex portion (412) when the upper fan blade (22) and the lower fan blade (23) are in a leeward condition. As a result, the drive linkage (53) upward and outward drags the upper linkage (51) and the lower linkage (52) to make the upper fan blade (22) and the lower fan blade (23) being closely moved relative to each other for reducing the coefficient of drag.

On the other hand, the second end of the drive linkage (53) is moved in the annular groove (413) within the concave portion (411) when the upper fan blade (22) and the lower fan blade (23) face the wind. As a result, the drive linkage (53) downward and inward drags the upper linkage (51) and the lower linkage (52) to make the upper fan blade (22) and the lower fan blade (23) being openly moved relative to each other for reducing the coefficient of drag and enhancing the use rate of the wind.

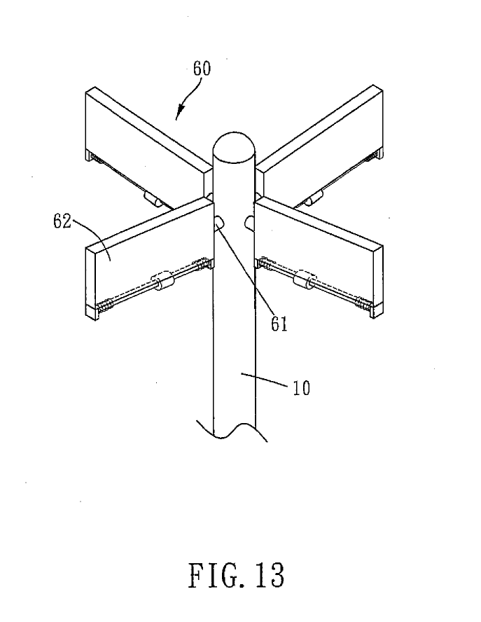

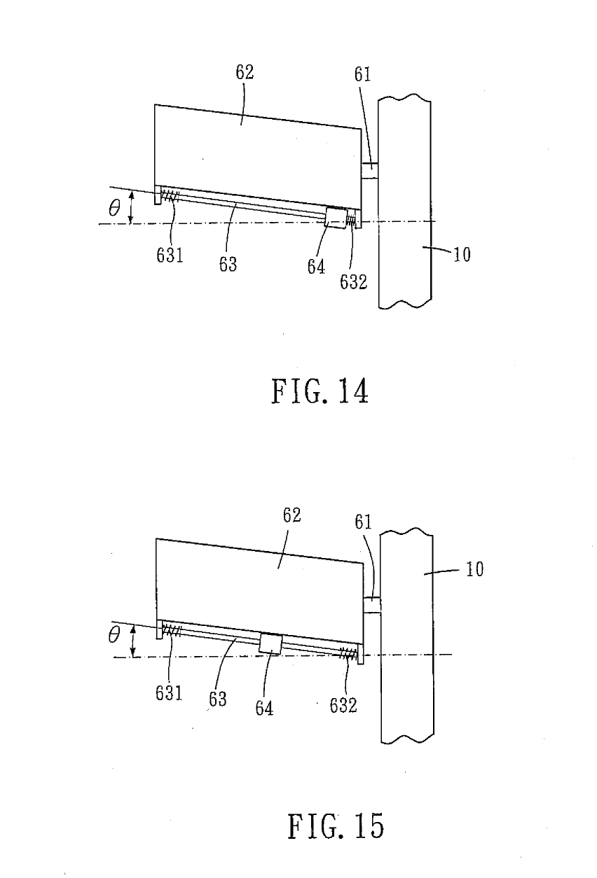

With reference to FIGS. 13 and 14 that show a sixth embodiment of the kinetic energy transforming module in accordance with the present invention, in the embodiment, the blade structure (60) has multiple shafts (61) radially extending from the main shaft (10) and outward sloped relative to the main shaft (10) to form an angle (θ) of elevation with the horizontal plane. Each shaft (61) has a fan blade (62) stably mounted thereon, wherein the blade (62) is perpendicular relative to the supporting surface. Each fan blade (62) has a guide rod (63) mounted to a lower edge thereof and the guide rod (63) has an axis parallel to that of the related fan blade (62). A counterweight block (64) is slidably mounted on the guide rod (63). A first buffer (631) and a second buffer (632) are respectively sleeved on the guide rod (63) relative to two opposite sides of the counterweight block (64), wherein the first buffer (631) is relative to a free end of the fan blade (62).

With reference to FIG. 15, the counterweight block (64) is moved toward the free end of the fan blade (62) due to the centrifugal force from the rotating blade structure (60) to enhance torque and rotate inertia of the blade structure (60). Consequently, the inertia of the counterweight block (64) will continually drive the blade structure (60) when the wind stops or slow down. The first buffer (631) is provided to prevent the counterweight block (64) from detaching from the guide rod (63) and striking the free end of the fan blade (62) when the wind is strong. The second buffer (632) can prevent the counterweight block (64) from striking the main shaft (10) when the wind stops.

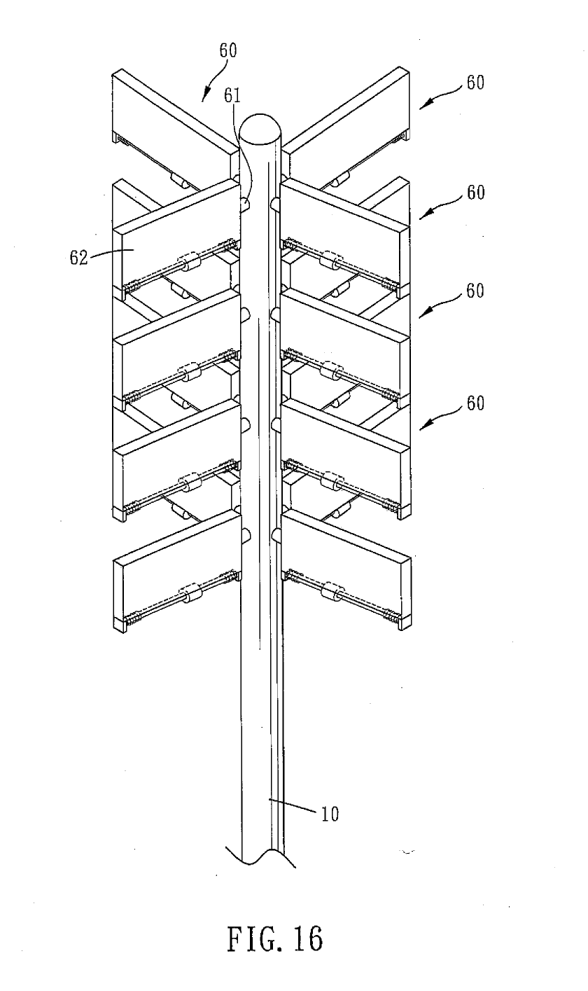

With reference to FIG. 16 that shows a seventh embodiment of the kinetic energy transforming module in accordance with the present invention, in the embodiment, multiple blade structures (60) are parallel to one another and sequentially mounted on the main shaft (10) for providing heavy power when the load of the main shaft (10) is great.

Although the invention has been explained in relation to its preferred embodiment, it is to be understood that many other possible modifications and variations can be made without departing from the spirit and scope of the invention as hereinafter claimed.

What is claimed is:

1. A kinetic energy transforming module comprising:
a main shaft perpendicularly and rotatably standing on supporting surface;
at least one blade structure horizontally mounted on the main shaft for driving the main shaft via wind power, the blade structure including:
multiple shafts horizontally and radially extending from the main shaft, each shaft having a curve upper groove and a curve lower groove respectively and transversely defined in an outer periphery thereof, wherein the upper groove has two opposite sides respectively formed with a lower stopper and an upper stopper, a first includes angle formed between the lower stopper and the horizontal plane being greater than 0 degree, and a second included angle formed between the upper stopper and the horizontal plane being smaller than 90 degrees, the lower groove having a lower side formed with a stopper that is vertical relative to the horizontal plane; and
an upper fan blade and a lower fan blade respectively having a hinged side pivotally sleeved on the shaft such that the upper fan blade and the lower fan blade can be freely rotated relative to the shaft within the upper groove and the lower groove.

2. The kinetic energy transforming module as claimed in claim 1, wherein multiple blade structures are parallel to one another and sequentially mounted on the main shaft for providing heavy power when the load of the main shaft is great.

3. The kinetic energy transforming module as claimed in claim 1, wherein the rotation angle of the upper fan blade is limited within 5 to 90 degrees and the rotation angle of the lower fan blade is limited within −15 to −90 degrees for keeping the upper and lower blades rotating and accelerating to achieve higher wind power efficiency.

4. The kinetic energy transforming module as claimed in claim 1, wherein the shaft has two opposite ends each having a generating device mounted thereon, each generating device having two permanent magnets respectively laterally extending from a corresponding edge of the upper fan blade and the lower fan blade, two connecting rods radially extending from the shaft and a curve induction coil secured on a free end of each of the two connecting rods, each induction coil corresponding to a moving route of a corresponding one of the two permanent magnets such that the generating device generates electric power due to the Faraday Law when the upper fan blade and the lower fan blade are wiggles relative to the shaft.

5. The kinetic energy transforming module as claimed in claim 4, wherein the corresponding permanent magnet and induction coil can be exchanged.

6. The kinetic energy transforming module as claimed in claim 1 further comprising a driving unit sleeved on the main shaft and a linkage set connecting to the upper fan blade and the lower fan blade for operating the upper fan blade and the lower fan blade.

7. The kinetic energy transforming module as claimed in claim 6, wherein the driving unit includes a cam sleeved on the main shaft and the main shaft is rotatable relative to the cam, the cam having an upper surface divided into a concave portion and convex portion, and an annular groove defined along the concave portion and the convex portion.

8. The kinetic energy transforming module as claimed in claim 7, wherein the linkage set includes an upper linkage, a lower linkage and a drive linkage pivotally connected to one another.

9. The kinetic energy transforming module as claimed in claim 8, wherein the upper linkage and the lower linkage respectively have a first end pivotally connected to a back of the upper fan blade and a back of the lower fan blade, and a second end pivotally connected to each other, the drive linkage having a first end pivotally connected to the second ends of the upper linkage and the lower linkage, and a second slidably received in the annular groove.

10. The kinetic energy transforming module as claimed in claim 9, wherein the linkage set includes a guide rod horizontally connected to the shaft and having a groove longitudinally defined therein for slidably receiving the first end of the drive linkage and two second ends of the upper linkage and the lower linkage.

11. A kinetic energy transforming module comprising:
a main shaft perpendicularly and rotatably standing on supporting surface;
at least one blade structure horizontally mounted on the main shaft for driving the main shaft via wind power, the blade structure including multiple shafts radially extending from the main shaft and outward sloped relative to the main shaft, each shaft having a fan blade stably mounted thereon, wherein the blade is perpendicular relative to the supporting surface, each fan blade having a counterweight block slidably mounted on a lower edge thereof to enhance torque and rotate inertia of the blade structure.

12. The kinetic energy transforming module as claimed in claim 11, wherein the fan blade has a guide rod mounted to a lower edge thereof and the guide rod has an axis parallel to that of the related fan blade, the counterweight block slidably mounted on the guide rod.

13. The kinetic energy transforming module as claimed in claim 12, wherein each fan blade includes a first buffer and a second buffer respectively sleeved on the guide rod relative to two opposite sides of the counterweight block, wherein the first buffer is relative to a free end of the fan blade.
